(19) United States
(12) Patent Application Publication
(10) Pub. No.: US 2009/0216837 A1
(43) Pub. Date: Aug. 27, 2009

(54) SECURE RESERVATIONLESS CONFERENCING

(75) Inventors: Deepak Rao, Bellevue, WA (US); Dhigha Sekaran, Redmond, WA (US); Vadim Eydelman, Redmond, WA (US)

Correspondence Address: MICROSOFT CORPORATION, ONE MICROSOFT WAY, REDMOND, WA, 98052-6399, US

(73) Assignee: MICROSOFT CORPORATION, Redmond, WA (US)

(21) Appl. No.: 12/037,075

(22) Filed: Feb. 25, 2008

(51) Int. Cl. G06F 15/16

(52) U.S. Cl. 709/204

(57) ABSTRACT

Techniques are disclosed providing secure reservationless conferencing, allowing an organizer to arrange a meeting while off-line from a conferencing server, with the conferencing server still enforcing security for the meeting.

### BACKGROUND

Online conferencing solutions are used to ease the process of setting up telephonic or video conferences. Such conferences have been gaining in popularity with improved bandwidth on the internet. Typically to schedule a conference, an organizer contacts a conferencing server and reserves the necessary resources before inviting people to attend. This is referred to as “Reservation Conferencing” because it allows the conferencing server to allocate sufficient resources for the conference before hand.

However, there are situations when the organizer might be offline from the conferencing server. In such a case, the organizer's conference scheduling application will usually implement a queue of pending server requests and send out meeting invitations only after successfully sending those requests to the conferencing server.

### SUMMARY

Described herein are, among other things, techniques for providing an ability to create a conference without requiring reserving server resources beforehand.

In accordance with one implementation presented herein this functionality is provided by allowing an authorized meeting organizer to send meeting invitations to invitees without reserving this meeting on the conference server. The conference server may then securely host the meeting without the organizer having contacted it regarding that meeting by cryptographically verifying that the invitation being presented was indeed created by the organizer.

### DESCRIPTION OF THE DRAWINGS

The detailed description provided below in connection with the appended drawings is intended as a description of example implementations and is not intended to represent the only forms in which software execution with minimal impact deployment may be constructed or utilized. The description sets forth the functions of example implementations and the sequence of steps for constructing and operating the examples. However, the same or equivalent functions and sequences may be accomplished by alternate implementations.

FIG. 1 is a block diagram of an example Operating Environment in which reservationless conferencing may be implemented.

FIG. 2 is a block diagram of an alternate example Operating Environment in which reservationless conferencing may be implemented.

FIG. 3 is a block diagram showing an example of additional details of key exchanges between the Conferencing Server and the Scheduling Client.

FIG. 4 is a block diagram showing additional details for one implementation of communications between scheduling clients, invitee clients and conferencing servers.

FIG. 5 shows an example of a computing device for implementing one or more embodiments of the invention.

### DETAILED DESCRIPTION

Described herein are, among other things, examples of various technologies and techniques that allow secure reservationless conferencing. Although the examples are described and illustrated herein as being implemented in a personal computer system, the system described is provided as an example and not a limitation. As those skilled in the art will appreciate, the present examples are suitable for application in a variety of different types of systems.

In the figures, like reference numerals are used throughout several drawings to refer to similar components.

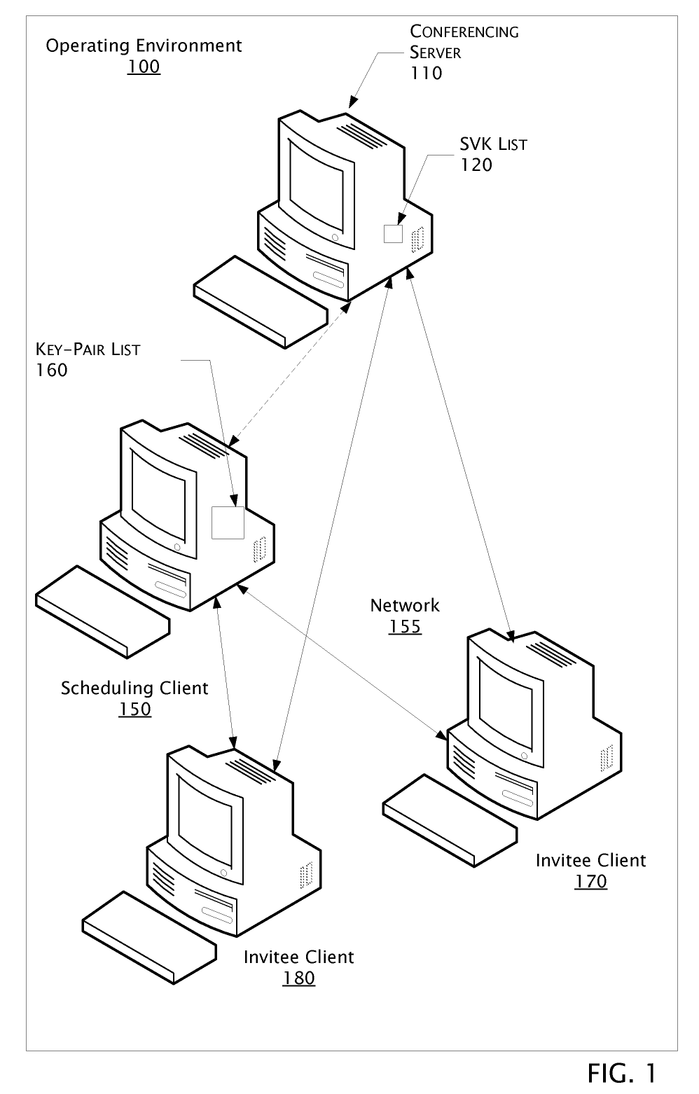

FIG. 1 is a block diagram of an example Operating Environment 100 in which reservationless conferencing may be implemented.

A conference or meeting may be identified by two pieces of information, an authorized organizer's identity, and a conference identifier, which will together be referred to as CID There may be options for a conference, such as date and time, list of invitees, recording settings, compulsory attendees, etc., which will be referred to as Conference Options (CO). When the CID and CO are presented to the Conferencing Server 110 by any invitee to the conference, the Conference Server 110 must verify that the presented data was indeed generated by the specified organizer and has not been tampered with. This may be done through the use of cryptographic digital signature key-pairs.

In at least one implementation, an organizer will generate a key-pair for each machine the organizer wishes to use to schedule conferences. A key-pair will have an expiration time associated with it, and the private key, or Signing Key (SK), may be used to digitally sign data, such as meeting invitations, sent by the organizer. An expiration time may increase security by ensuring key-pairs get refreshed periodically and are less vulnerable to anyone trying to determine the keys. The public key, or Signature Verification Key (SVK), must be communicated to the Conferencing Server 110 once prior to the organizer scheduling meetings. The SK/SVK pair has an expiration time associated with it. In another implementation there are more than one Scheduling Clients 150, and each needs an SK/SVK pair. To match the SVK with the proper Scheduling Client 150, a SVK ID is used, which is a globally unique identifier, such as a GUID, generated by the Scheduling Client and sent to the Conferencing Server 110. In another implementation the SK/SVK key pair and a SVK ID will be generated on Conferencing Server 110, with the SK and SVK ID being passed securely to Scheduling Client 150. One skilled in the art will recognize that there are a number of techniques to generate and pass keys to allow secure transference of conference options.

To allow the server to track which organizer-machine combination generated a conference, an ID associated with the SVK may also be used. Additionally, to secure communications regarding Conference Options, encryption may be used.

In this example, Scheduling Client 150 contains Key-Pair List 160, and the SVKs have previously been communicated with Conferencing Server 110, which has a stored Signature Verification Key List 120. At this time, Scheduling Client 150 does not have Network 155 connectivity with Conferencing Server 110, but does with Invitee Clients 170, 180.

Scheduling Client 150 sends meeting invitations to Invitee Clients 170 and 180. Meeting invitations contain the CID, CO and are signed with a digital signature computed using the Signing Key. At the time of the meeting, Invitee Clients 170, 180 may communicate with and pass the all the data obtained from the meeting invitation to Conferencing Server 110, which may then verify the included digital signature by using the Signature Verification Key. Another client attempting to join the meeting may be blocked by Conferencing Server 110 if it does not provide a verifiable digital signature.

While FIG. 1 shows one Conferencing Server 110, one Scheduling Client 150, and two Invitee Clients 170, 180, and a Network 155, one skilled in the art will recognize that any number of server and client devices may make up such an operating environment. Network 155 may be a local area network, or a wide area network, and may use the Internet for communication. Network 155 may be any configuration, included wired, fiber optic, wireless, a combination of the two, etc. An alternative implementation uses removable media to transfer the Signing Key from the Scheduling Client 150 to the Invitee Clients 170, 180.

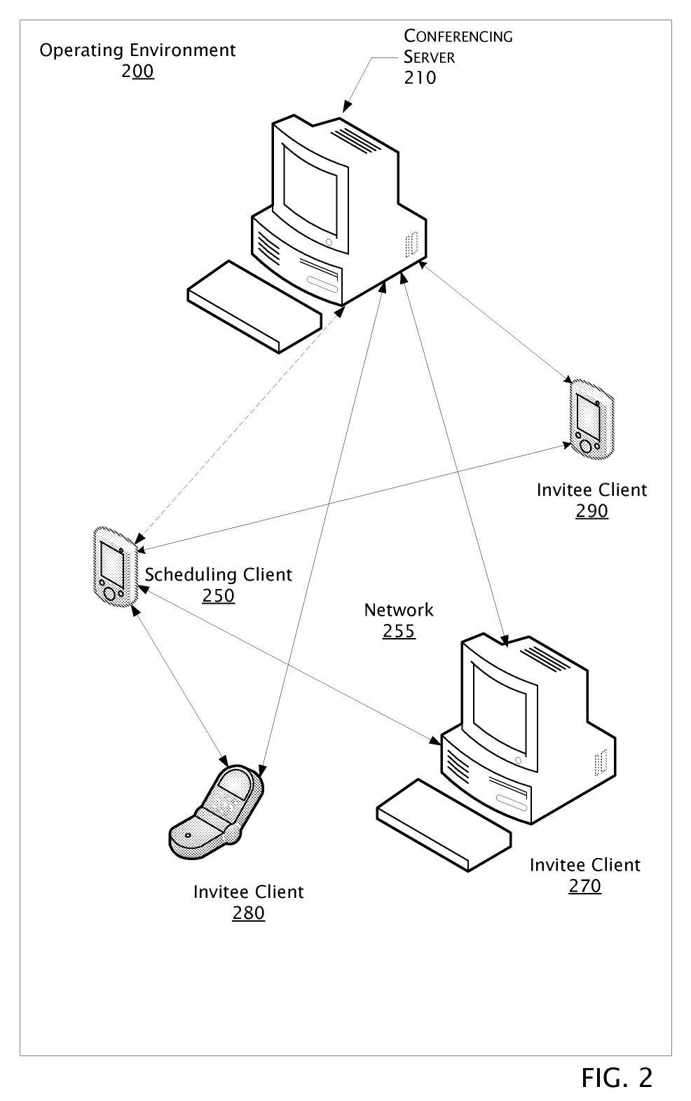

FIG. 2 is a block diagram of an alternate example Operating Environment 200 in which reservationless conferencing may be implemented. In this example, Scheduling client 250 is a mobile device, a personal digital assistant (PDA), for example. Scheduling Client 250 previously communicated with Conferencing Server 210, exchanging keys in a similar manner to Scheduling Client 110 on FIG. 1. Network 255 includes a local area network connecting Invitee Client 270 and Conferencing Server 210. Network 255 also includes wide area network capability, allowing Scheduling Client 250 to send meeting invitations to Invitee Client 270, Invitee Client 280, and Invitee Client 290. Each of the Invitee Clients 270, 280, and 290, may then communicate with Conferencing Server 210 and join the meeting Scheduling Client 250 originated.

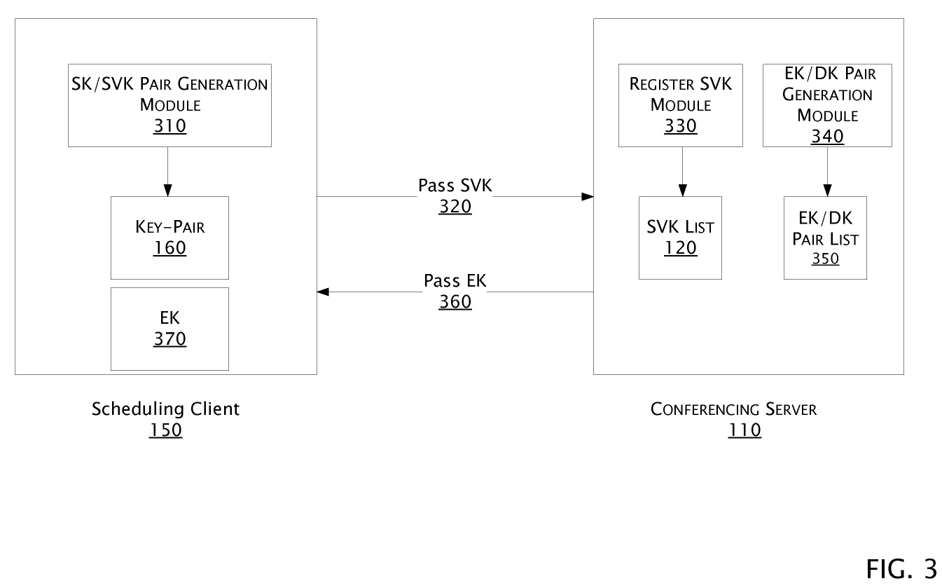

FIG. 3 is a block diagram showing additional details of key exchanges between the Conferencing Server 110, and the Scheduling Client 150. Scheduling Client 120 uses SK/SVK Pair Generation Module 310 to generate an SK/SVK key-pair, which gets stored in Key-Pair List 160. Scheduling Client 150 also transfers 320 a Signature Verification Key to Conferencing Server 110, which allows Conferencing Server 110 to verify data digitally signed by Scheduling Client 150. Register SVK Module 330 adds the SVK, to SVK List 120.

Conferencing Server 110 generates an Encryption Key/Decryption Key Pair using the Generate EK/DK Pair module, and adds them to EK/DK Pair List 350, as well as passing 360 the EK back to Scheduling Client 150, which then stores a copy 370. Scheduling Client 150 then uses the Encryption Key to encrypt Conference Options. The Decryption Key then allows Conferencing Server 110 to access the encrypted conference options. The EK/DK pair has an expiration time associated with it. In another implementation there are more than one Scheduling Clients 150, and each needs an EK/DK pair from Conferencing Server 110. To match the DK with the proper Scheduling Client 150, a DK ID is used, which is a GUID generated by the Scheduling Client and sent to the Conferencing Server 110 in a request for an encryption key. In yet another implementation, Scheduling Client 150 does not use encryption to secure conference options. In another implementation the DK/EK key pair will be generated on Scheduling Client 150, with the DK being passed to Conferencing Server 110. One skilled in the art will recognize that there are many techniques to implement secure passing of conference options, and that there are implementations where encryption is not used.

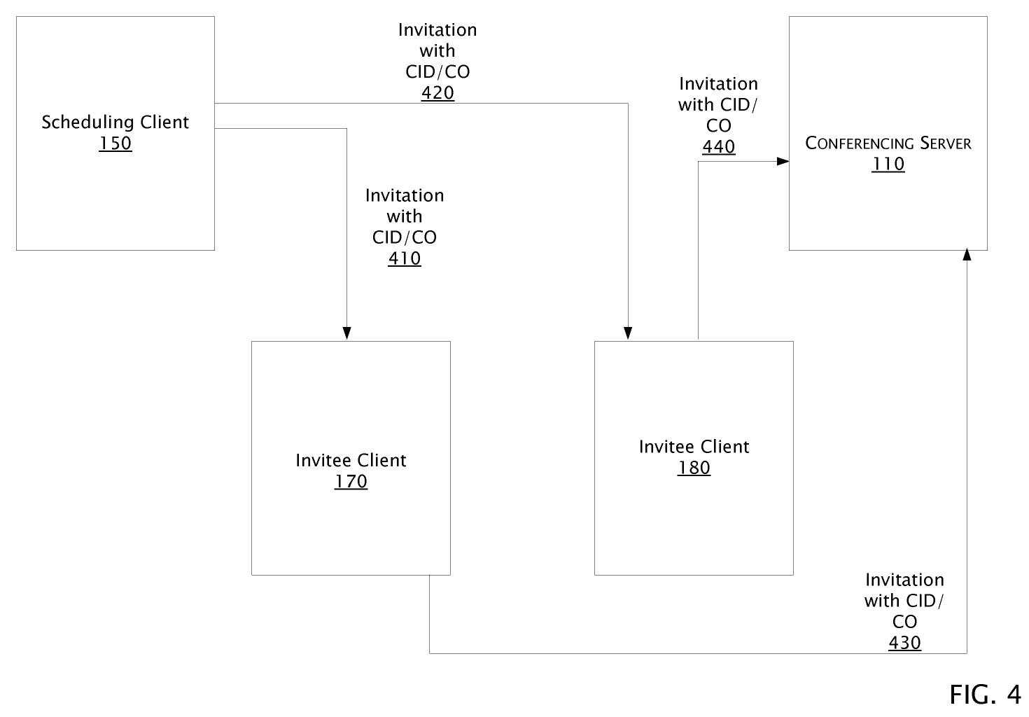

FIG. 4 is a block diagram showing additional details for one implementation of communications between Scheduling Client 150, Invitee Clients 170, 180 and Conferencing Servers 110. When scheduling a meeting, Scheduling Client 150 sends 410 an invitation to Invitee Client 170 and sends 420 one to 180. The invitations include the Conference ID and Conference Options, which are signed by Scheduling Client 150, which calculates a signature using a stored signature key. The CO are encrypted with an Encryption Key, also associated with Scheduling Client 150.

When it is time to attend the meeting, Invitee Client 170 sends 430 the invitation with the CID and CO to Conferencing Server 110. Conferencing Server 110 uses a Signature Verification Key to verify that the data originated with Scheduling Client 150, and a Decryption Key to decrypt the CO. Invitee Client 170 will be permitted to start the meeting. A similar process is followed for Invitee Client 180, which sends 440 the invitation containing the CID and CO it received to Conferencing Server 110, allowing Invitee Client 180 to join the meeting.

In another implementation, Scheduling Client 150 may also be connected at the time of the meeting, and may also attend by an invitation including CID and CO information to Conferencing Server 110.

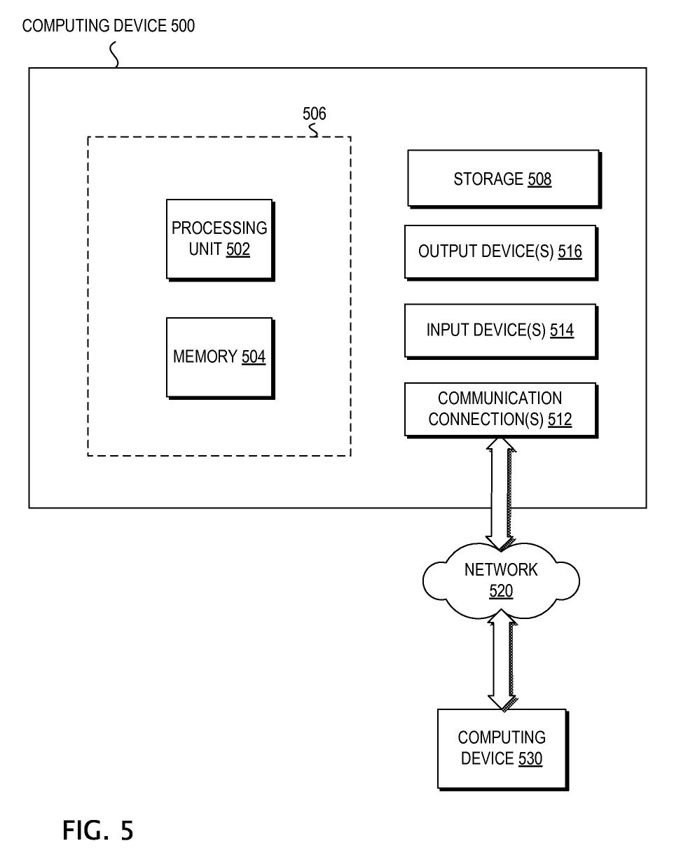

FIG. 5 shows an example of a computing device 500 for implementing one or more embodiments of the invention. In one configuration, computing device 500 includes at least one processing unit 502 and memory 504. Depending on the exact configuration and type of computing device, memory 504 may be volatile (such as RAM), non-volatile (such as ROM, flash memory, etc.) or some combination of the two. This configuration is illustrated in FIG. 5 by dashed line 506.

In other embodiments, device 500 may include additional features and/or functionality. For example, device 500 may also include additional storage (e.g., removable and/or non-removable) including, but not limited to, magnetic storage, optical storage, and the like. Such additional storage is illustrated in FIG. 5 by storage 508. In one embodiment, computer readable instructions to implement embodiments of the invention may be in storage 508. Storage 508 may also store other computer readable instructions to implement an operating system, an application program, and the like.

The term “computer readable media” as used herein includes computer storage media. Computer storage media includes volatile and nonvolatile, removable and non-removable media implemented in any method or technology for storage of information such as computer readable instructions or other data. Memory 504 and storage 508 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 500. Any such computer storage media may be part of device 500.

Device 500 may also include communication connection(s) 512 that allow device 500 to communicate with other devices. Communication connection(s) 512 may include, but is not limited to, a modem, a Network Interface Card (NIC), or other interfaces for connecting computing device 500 to other computing devices. Communication connection(s) 512 may include a wired connection or a wireless connection. Communication connection(s) 512 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, Near Field Communication (NFC), and other wireless media.

Device 500 may include input device(s) 514 such as keyboard, mouse, pen, voice input device, touch input device, infrared cameras, video input devices, and/or any other input device. Output device(s) 516 such as one or more displays, speakers, printers, and/or any other output device may also be included in device 500. Input device(s) 514 and output device(s) 516 may be connected to device 500 via a wired connection, wireless connection, or any combination thereof. In one embodiment, an input device or an output device from another computing device may be used as input device(s) 514 or output device(s) 516 for computing device 500.

Components of computing device 500 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 500 may be interconnected by a network. For example, memory 504 may be comprised of multiple physical memory units located in different physical locations interconnected by a network.

Those skilled in the art will realize that storage devices utilized to store computer readable instructions may be distributed across a network. For example, a computing device 530 accessible via network 520 may store computer readable instructions to implement one or more embodiments of the invention. Computing device 500 may access computing device 530 and download a part or all of the computer readable instructions for execution. Alternatively, computing device 500 may download pieces of the computer readable instructions, as needed, or some instructions may be executed at computing device 500 and some at computing device 530. Those skilled in the art will also realize that all or a portion of the computer readable instructions may be carried out by a dedicated circuit, such as a Digital Signal Processor (DSP), programmable logic array, and the like.

1. A system comprising:
a processor;
a conferencing module configured to provide resources for an on-line conference;
a receiving module configured to receive conference options from an invitee, the invitee not being an organizer of the conference;
a verification module configured to verify the received conference options originated with the organizer of the conference;
a joining module configured to permit an invitee to join the conference if the received conference options originated with the conference organizer.

2. The system of claim 1 wherein the verification module uses a signature verification key to verify the received conference options originated with an organizer of the conference.

3. The system of claim 1 wherein the resources comprise audio conferencing support.

4. The system of claim 1 wherein the resources comprise video conferencing support.

5. The system of claim 1 wherein the receiving module receives conference options from a local area network.

6. The system of claim 1 wherein the receiving module receives conference options from a wide area network.

7. A method comprising:
receiving at a conference server conference options for a meeting from an invitee to the meeting;
verifying that the conference options originated by an authorized meeting originator who is not currently on-line with a conference server; and
providing resources for the meeting.

8. The method of claim 7 wherein the verifying step is done using a signature verification key.

9. The method of claim 7 wherein the conference options are received via a local area network.

10. The method of claim 7 wherein the conference options are received via a wide area network.

11. The method of claim 7 wherein the resources comprise audio conferencing support.

12. The method of claim 7 wherein the resources comprise video conferencing support.

13. The method of claim 7 wherein the resources comprise file sharing support.

14. Computer readable storage media, with instructions stored thereon that, when executed, perform the following method:
receiving at a conference server conference options for a meeting from an invitee to the meeting;
verifying that the conference options originated by an authorized meeting originator who is not currently on-line with a conference server; and
providing resources for the meeting.

15. The method of claim 14 wherein the verifying step is done using a signature verification key.

16. The method of claim 14 wherein the conference options are received via a local area network.

17. The method of claim 14 wherein the conference options are received via a wide area network.

18. The method of claim 14 wherein the resources comprise audio conferencing support.

19. The method of claim 14 wherein the resources comprise video conferencing support.

20. The method of claim 14 wherein the resources comprise file sharing support.
